(19) United States
(12) Patent Application Publication
(10) Pub. No.: US 2026/0031991 A1
(43) Pub. Date: Jan. 29, 2026

(54) METHOD FOR GENERATING AN ASSET-BACKED TOKEN WITH A DIGITAL VALUE-ADD (PULSE TOKENIZATION)

(71) Applicant: Blue Storm Media Inc, redwood city, CA (US)

(72) Inventor: Gareth Llewelyn, Hign Wycombe (GB)

(21) Appl. No.: 19/189,335

(22) Filed: Apr. 25, 2025

Related U.S. Application Data
(63) Continuation-in-part of application No. 18/973,182, filed on Dec. 9, 2024.
(63) Continuation-in-part of application No. 18/736,969, filed on Jun. 7, 2024.

(51) Int. Cl. H04L 9/32; H04L 9/00

(52) U.S. Cl. CPC H04L 9/3213; H04L 9/3236; H04L 9/50; H04L 2209/56

(57) ABSTRACT

The present invention relates to a method for generating an asset-backed token for exchange. The method comprises the steps of embedding a scanning element into the physical asset, and the scanning element is configured to enable digital authentication of the asset and provide access to a digital gateway. Further, calculating a valuation for the asset-backed token based on a predefined criteria incorporating at least one of the physical asset's initial market value, historical significance, emotional value, or associated digital content exclusivity. Furthermore, generating a plurality of digital tokens or intelligent units (I.U's) backed by the asset, and the number of I.U's is derived from dividing the asset's valuation by a predefined currency unit. Further, locking and encrypting the asset-backed I.U's within a secure digital ledger for exchange over a network. Finally, the asset-backed I.U's are securely locked and encrypted within a digital ledger, enabling their exchange over a network.

### FIELD OF THE INVENTION

The present invention discloses systems and methods for generating, transferring, and redeeming an asset-backed token, and more particularly, generating a fractionalized interest in the added value of the physical asset via a digital gateway (pulse tokenization).

### BACKGROUND

### Interpretation Considerations

This section describes the technical field in detail and discusses problems encountered in the technical field. Therefore, statements in the section are not to be construed as prior art.

### DISCUSSION

The collectibles and luxury asset markets have experienced remarkable growth in recent years, driven by global access, digital commerce, and heightened cultural interest. Y et beneath the surface, the ecosystem remains fragmented and outdated, burdened by persistent issues that undermine trust, limit transparency, and reduce meaningful engagement.

One of the most critical problems is authentication. Counterfeiting, fraud, and unverifiable provenance continue to plague both physical and digital assets. Verification methods ranging from printed certificates and serial numbers to basic digital tags are often centralized, static, and easily decoupled from the asset itself. As a result, ownership remains vulnerable to manipulation and misinformation.

Another major challenge is the absence of a dynamic, standardized method of valuation. Asset value is too often dictated by speculation, subjective appraisals, or historical sale data, rather than real-time cultural relevance or actual engagement. Value becomes a frozen number, disconnected from the ways an object is experienced, shared, or appreciated by a community. Without a mechanism to capture ongoing interaction or contextual significance, the deeper story of the asset and its true worth remains untold.

In response, several emerging solutions have attempted to address these gaps: blockchain-based certificates of authenticity, NFT-backed items, and serialized QR tags. While these approaches introduce traceability and ownership proof, they are typically siloed and static, offering only a snapshot in time rather than a continuous, living connection. They prove that something is real or owned, but they don't evolve with the asset. They fail to capture sentiment, interaction, or cultural momentum, and rarely provide any meaningful engagement after the point of sale.

Meanwhile, the tokenization of real-world assets (RWAs) has become another widely adopted strategy, typically used to divide ownership into digital shares. However, this model comes with a critical limitation: tokenization in its current form often requires the asset to be held by a third-party custodian. In doing so, it detaches the asset from the real world, turning it into a passive financial instrument rather than an interactive object. The asset can no longer be touched, displayed, or used in meaningful ways, either physically or digitally. In short, it becomes isolated from the very qualities that gave it value in the first place.

What's missing is a living connection, a new standard that transforms ownership into ongoing experience, turns value into real-time feedback, and reimagines assets as evolving digital beings. A system that doesn't just prove authenticity or offer partial control, but activates the asset into a responsive, participatory ecosystem where community interaction, cultural signals, and engagement directly shape its digital presence and perceived value. In this new paradigm, each asset carries a visible, evolving pulse, a real-time signal of its cultural life and ongoing engagement.

### SUMMARY

An objective of the present invention is to provide a method for generating an asset-backed token for exchange in which token holders digitally interact with the physical asset to create cross-value streams, bridging the gap between physical and digital assets.

Another object of the present invention is to provide token holders with fractional ownership of a change in value and digital participation, while physical custodians retain tangible ownership, offering a hybrid model of engagement.

Yet another object of the present invention is to foster community-driven experiences and storytelling through a curated digital gateway, enhancing the emotional and market value of assets over time.

Yet another object of the present invention is to provide real-time valuation updates, allowing physical and token holders to track changes in asset value and make informed decisions.

Still another object of the present invention is to provide a method that enables luxury brands to leverage Value Bonding to extend their legacy into digital spaces, preserving heritage while engaging new audiences through co-branded initiatives or white-label integrations.

Still another object of the present invention is to provide a platform for cultural preservation and value creation, inviting collectors, creators, and connoisseurs to co-author the future of luxury assets.

Further yet, an object of the present invention is to provide a method for integrating streaming platform data, such as Spotify listenership demographics, to effectively target potential token holders, thereby bridging the gap between digital engagement and physical asset ownership. Another object of the present invention is to utilize data extraction techniques, including scraping publicly available information from streaming platforms, to inform and optimize marketing strategies for Intelligent Units (IUs) or digital tokens associated with physical items linked to specific artists. Yet another object of the present invention is to enable the analysis of user-generated content and listening behaviors to identify and reach audiences most likely to engage with and invest in tokenized physical assets, enhancing the precision and effectiveness of promotional efforts.

In summary, the present invention addresses the challenges and shortcomings of the conventional art by transforming luxury collectibles into dynamic assets by combining technology, tokenization, and community engagement. This offers secure authentication, fractional ownership of value changes, real-time valuation updates, and enhanced brand engagement, while preserving cultural heritage and creating new values. This bridges the physical and digital worlds, making luxury more accessible and engaging for both brands and collectors.

This and other objectives are achieved by providing a method for generating an asset-backed token for exchange with the features of the independent claims. Further advantageous embodiments and improvements of the invention are listed in the dependent claims. Hereinafter, expressions like “ . . . aspect according to the invention” or “according to the invention” or similar, related to the technical teaching of the broadest embodiment as claimed with the independent claims.

According to a first aspect of the present invention, the present invention discloses a method for generating an asset-backed token for exchange. The method comprises the steps of embedding a scanning element into the physical asset, and the scanning element is configured to enable digital authentication of the asset and provide access to a digital gateway. Further, calculating a valuation for the asset-backed token based on a predefined criterion, incorporating at least one of the physical asset's initial market value, historical significance, emotional value, or associated digital content exclusivity. Furthermore, generating a plurality of digital tokens or intelligent units (I.U's) backed by the asset, and the number of I.U's is derived from dividing the asset's valuation by a predefined currency unit. Further, locking and encrypting the asset-backed I.U's within a secure digital ledger for exchange over a network.

In an embodiment of the present invention, the method further comprises tracking the demand for the physical asset and adjusting the valuation of the I.U's based on changes in market interest. This adaptive approach ensures that the value of the asset-backed tokens remains aligned with current market conditions, reflecting changes in demand and sentiment. By integrating real-time market data, the method provides a more accurate and responsive valuation mechanism, enhancing the overall efficiency and relevance of the asset-backed token market. This dynamic valuation process supports a more agile and responsive financial ecosystem, where asset values can adjust quickly to shifts in market dynamics. Ultimately, this method helps maintain the integrity and attractiveness of the asset-backed tokens by ensuring they reflect the most current market realities.

In another embodiment of the present invention, the method further comprises monitoring interactions with the digital gateway, including user engagement levels, access frequency, number of interactions, and content exclusivity, to determine their effect on the token value. This approach allows for a more detailed understanding of how digital engagement affects the financial value of the tokens, providing a dynamic and responsive valuation mechanism that reflects both physical and digital market dynamics.

Yet another embodiment of the present invention, the method further comprises updating the value of the I.U's dynamically in response to at least one of an increase in access privileges, an enhancement of the digital footprint associated with the asset, or a change in ownership status. This dynamic valuation method ensures that the value of the I.U's remains responsive to changes in the asset's digital and physical attributes, reflecting its evolving market relevance and appeal.

In still another embodiment of the present invention, the method further comprises recalculating the I.U's value based on the modified asset valuation and recording the adjusted value in an immutable transaction. This ensures that all transactions and valuations are secure, auditable, and resistant to alteration, thereby maintaining trust and confidence in the asset-backed token ecosystem.

In still another embodiment of the present invention, the method further comprises embedding a display of value (DOV) on the physical asset. The DOV is configured to present a color and symbol-coded representation of the I.U's valuation, and the color and symbol code corresponds to at least one of a valuation tier of the asset, the digital gateway access level, or the number of I.U's available. The method provides a visually intuitive, color and symbol-coded representation of the intelligent units' valuation, enhancing transparency and accessibility for users. In one example, a 3D-enhanced display of value (DOV) bridges physical and digital realms by embedding valuation data directly onto assets, using a visually intuitive 3D representation. The color and symbol coding reflect valuation tiers, access levels, or intelligent unit availability, while depth and height in the topology add tactile clarity. Users may explore this dynamic landscape interactively, rotating and zooming through textured surfaces that highlight stability or volatility, ensuring transparency and accessibility in decision-making.

In still another embodiment of the present invention, the DOV is at least one of a fixed, programmable, or dynamically updating display that changes based on real-time valuation of at least one of the asset, the digital gateway, or I.U's. The DOV dynamically updates in real-time to reflect changes in asset valuation, digital gateway access levels, or the availability of intelligent units, providing users with an intuitive and constantly accurate representation of the asset's value.

In still another embodiment of the present invention, the DOV is configured to visually indicate the rate of interaction or usage of the I.U's. A change in the interaction frequency updates at least one of the color or symbol coding on the DOV. The DOV visually indicates the rate of interaction or usage of the intelligent units, dynamically updating its color or symbol coding to reflect changes in interaction frequency, providing real-time feedback on engagement levels.

In still another embodiment of the present invention, the DOV is further configured to indicate an ownership status or transaction history of the asset by displaying a unique identifier. The identifier is updated upon a verified transfer of ownership over a secured network. The DOV provides a unique identifier to indicate ownership status and transaction history, updating securely upon verified transfers to ensure transparent and tamper-proof tracking of asset ownership.

In still another embodiment of the present invention, the DOV is embedded with a location-tracking mechanism to authenticate the continued presence of the DOV on the asset, preventing unauthorized removal or tampering, and ensuring valuation integrity.

According to a second aspect of the present invention, a method is disclosed for generating an asset-backed token for exchange. The method involves embedding a keepsake display into a physical asset, where the display is designed to showcase a commemorative or historically significant item. A scanning element is also embedded into the asset, enabling digital authentication of the keepsake and providing access to a digital gateway. A valuation for the asset-backed token is then determined based on predefined criteria, which may include the asset's initial market value, historical or emotional significance, or the exclusivity of any related digital content. Based on this valuation, a set of intelligent units (I.U.'s) is generated, with the quantity derived by dividing the total value of the asset by a predetermined currency unit. These I.U.'s are then securely locked and encrypted within a blockchain or digital ledger system. A display of value (DOV) is added to the physical asset, presenting a color- and symbol-coded visual that reflects the token's valuation. This code may also indicate the asset's valuation tier, digital gateway access level, or the number of I.U.'s available.

In an alternate embodiment of the present invention, the scanning element may be embedded into any physical item, even in the absence of a keepsake display. The scanning feature alone can enable digital authentication, provide gateway access, or allow tokenization of luxury or collectible items that merit authentication, even if a keepsake is not included. In other configurations, physical items, whether or not they include a keepsake, may be scanned, authenticated, and made accessible via the digital gateway or tokenized, without displaying any indication of value or real-time valuation.

In one embodiment of the present invention, the embedded scanning element, as mentioned in step b), may facilitate digital authentication by enabling video recording during the scanning/authentication process. The video recording captures and documents the exact state of the keepsake, embedded components, and the authentication action itself, creating an immutable visual record stored alongside the digital gateway access logs. The recorded footage serves as irrefutable evidence of the asset's physical-digital linkage, ensuring transparency in verifying the keepsake's integrity and the legitimacy of its tokenized counterpart.

In an embodiment of the present invention, the digital ledger for recording and managing the asset-backed I.U's is implemented on a decentralized blockchain network to ensure security, transparency, and immutability of transactions.

In an embodiment of the present invention, the method further comprises applying a cryptographic hash function to secure the valuation data and transaction records of the I.U's, preventing unauthorized modifications.

In another embodiment of the present invention, the scanning element is configured to communicate with a smart contract encoded on the blockchain. The smart contract automatically enforces transaction rules for I.U transfers, asset ownership, and valuation updates.

In still another embodiment of the present invention, the I.U's are configured to enable transferability while maintaining a secure linkage to the underlying physical asset.

In still another embodiment of the present invention, the method further comprises embedding a biometric authentication mechanism within the digital gateway to restrict access to the asset-backed I.U's and prevent unauthorized transactions.

In still another embodiment of the present invention, the display of value is configured to update dynamically based on real-time valuation changes. The update is triggered by an algorithm analyzing market demand, digital engagement metrics, or transaction history. In one case, the method may trigger the update using an artificial intelligence (AI) algorithm and/or machine-learning models (LLM) to analyze market demand, digital engagement metrics, or transaction history.

In still another embodiment of the present invention, the display of value is further configured to display an ownership authentication marker. The marker is updated each time the asset-backed token is transferred to a new owner.

In still another embodiment of the present invention, the asset-backed token system further comprises an integrated auditing mechanism that verifies and logs all valuation updates, transactions, and ownership changes over a distributed ledger for regulatory compliance and fraud prevention. Further, in one case, the method may include media view analytics as part of the integrated auditing mechanism. The statistics track the visibility and engagement with token-related media content, providing additional transparency and insights into public interest and awareness. The feature complements the auditing mechanism by enriching the verification process with metrics that reflect public interaction. By logging valuation updates, transactions, ownership changes, and media engagement data on a distributed ledger, the method ensures regulatory compliance, fraud prevention, and enhanced accountability for stakeholders.

According to a third aspect of the present invention, the present invention discloses a method for enabling digital access and authentication of a physical asset. The method comprises the steps of: a) embedding a scanning element within or on a physical asset, wherein the scanning element is configured to store and transmit authentication data associated with the asset; b) linking the scanning element to a digital gateway, wherein the digital gateway provides access to at least one of ownership records, historical data, provenance, or exclusive digital content related to the asset; and c) enabling digital interactions associated with the asset through the digital gateway.

Tokens are generated and exchanged on the ValueBond platform and are unique to each individual asset. These tokens do not represent direct fractional ownership of the physical asset itself but rather represent the difference in value, the delta, between the asset's standalone baseline value and its evolving value when activated through the gateway. This evolving value is recalculated in real time, based on engagement metrics such as content uploads, viewership, social interaction, event participation, and other data inputs scraped and computed via the gateway.

The gateway may also function, in alternate embodiments, as a unified content and exchange portal, allowing for direct interaction and token-related transactions. Importantly, each stakeholder, whether a token holder or the physical asset holder, participates in the asset's cross-value stream. By interacting with the gateway, users actively contribute to the asset's perceived cultural and economic value. While physical asset holders contribute through real-world activation and stewardship, token holders benefit from the appreciation in value tied specifically to gateway-driven interaction and engagement. This system enables a new paradigm in asset authentication and valuation, transforming static ownership into a responsive, living ecosystem in which interaction and cultural relevance are tokenized and monetized through real-time feedback loops.

Further objectives, features, and advantages of the present invention will become apparent when studying the following detailed disclosure, the drawings, and the appended claims. Those skilled in the art will realize that different features of the present invention can be combined to create embodiments other than those described in the following.

### BRIEF DESCRIPTION OF THE DRAWINGS

Various aspects, as well as embodiments of the present invention, are better understood by referring to the following detailed description. To better understand the invention, the detailed description should be read in conjunction with the drawings.

FIG. 1 illustrates a system for generating an asset-backed token for exchange in accordance with an embodiment of the present invention;

FIG. 2 illustrates a schematic diagram of a system for generating an asset-backed token for exchange in accordance with an embodiment of the present invention;

FIG. 3 illustrates a process flow diagram for generating an asset-backed token for exchange in accordance with an embodiment of the present invention;

FIG. 4 illustrates a detailed process flow diagram for the lifecycle of a Value Bond (VB) and its associated Intelligent Units (IUs), encompassing registration, valuation, fractionalization, exchange, and resale dynamics of a value-bonded physical asset in accordance with an embodiment of the present invention;

FIG. 5 illustrates a screenshot of a landing page that demonstrates the process of selecting a value-bonded physical asset or product for value-bonding on a dedicated platform or server, in line with an exemplary embodiment of the present invention;

FIG. 6 illustrates a screenshot of a landing page that visually represents the step-by-step graphical flow of value bond creation, the transfer of a value-bonded physical asset, and the process by which the first purchaser, John Doe, unlocks the value-bond and lists the real-world digital asset for sale or purchase, in accordance with an exemplary embodiment of the present invention;

FIGS. 7-12 illustrate a series of landing pages on a value bond platform that guides the user through the process of selecting and purchasing intelligent units, in accordance with an exemplary embodiment of the present invention;

FIG. 13 illustrates a screenshot of landing page on the ValueBond App, depicting the process of selling intelligent units in accordance with an exemplary embodiment of the present invention;

FIG. 14 illustrates a screenshot of landing page depicting the process of buying intelligent units on the ValueBond App in accordance with an exemplary embodiment of the present invention;

FIG. 15 illustrates a screenshot of landing page, which depicts a gateway on the Value Bond App in accordance with an exemplary embodiment of the present invention;

FIG. 16 illustrates a screenshot of landing page depicting a gateway on the Value Bond A pp specifically for intelligent units, in accordance with an exemplary embodiment of the present invention; and

FIG. 17 illustrates a screenshot of landing page depicting a daily indicative price update for ValueBond on the ValueBond platform in accordance with an exemplary embodiment of the present invention.

The illustrated embodiments are merely examples and are not intended to limit the disclosure. The schematics are drawn to illustrate features and concepts and are not necessarily drawn to scale.

### DETAILED DESCRIPTION

The present disclosure is best understood with reference to the detailed figures and description set forth herein. Various embodiments have been discussed with reference to the figures. However, a person skilled in the art will readily appreciate that the detailed descriptions provided herein with respect to the figures are merely for explanatory purposes, as the methods and system may extend beyond the described embodiments. For instance, the teachings presented, and the needs of a particular application may yield multiple alternatives and suitable approaches to implement the functionality of any detail described herein. Therefore, any approach may extend beyond certain implementation choices in the following embodiments.

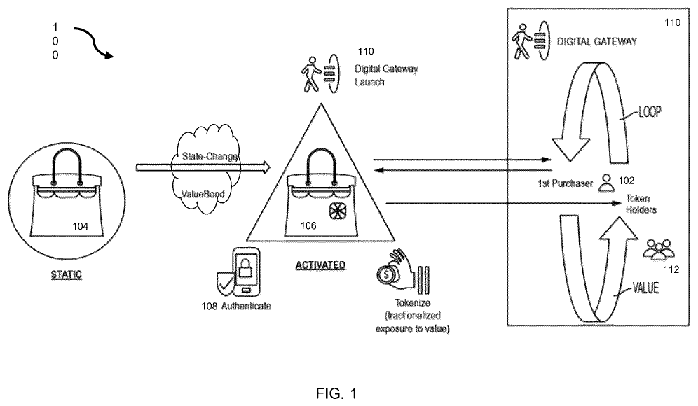

FIG. 1 illustrates a system 100 for generating an asset-backed token for exchange in accordance with an embodiment of the present invention. The system 100 comprises a first purchaser 102, a physical asset 104, a value-bonded physical asset 106, a mobile phone 108, a digital gateway 110, and one or more token holders 112.

The first purchaser 102 may receive a batch of manufactured physical assets 104 or choose existing physical assets 104 to value bond. Alternatively, the first purchaser 102 may receive value-bonded physical asset 106. In one example, the physical asset 104 is a handbag. In another example, the physical asset 104 may include but is not limited to a luxury item, collectible artwork, a commemorative or historically significant item, a prototype product, or a high-profile memorabilia piece.

The physical asset 104 (handbag) is embedded with a scanning element to create the value-bonded physical asset 106. Further, the physical asset 104 may be embedded with a keepsake display. The scanning element may include, but is not limited to, a secure chip, cryptographic marker, smart tag, near field communication (NFC) chip, radio-frequency identification (RFID) Chip.

The first purchaser 102 may perform authentication on the value-bonded physical asset 106. The first purchaser 102 uses a mobile phone 108 to authenticate the value-bonded physical asset 106.

The value-bonded physical asset 106 may be communicatively coupled to the digital gateway or server 110 using a network. The network may support any number of suitable wireless data communication protocols, techniques, or methodologies, including but not limited to a wireless fidelity Wi-Fi or IEEE 802.11 (any variation), global system for mobile communication (GSM), general packet radio service (GPRS), enhanced data rates for GSM Evolution (EDGE), long term evolution (LTE), cellular protocols (2G, 2.5G, 2.75G, 3G, 4G or 5G), near field communication (NFC), or any other protocols for wireless communication.

The scanning element enables digital authentication of the value-bonded physical asset 106 or the keepsake and provides access to the digital gateway or server 110. In one example, the scanning element is configured to store and transmit authentication data associated with the value-bonded physical asset 106. In another example, the digital gateway or server 110 may store data related to one or more value-bonded physical assets 106. In yet another example, the mobile phone 108 may enable the first purchaser 102 to register the one or more value-bonded physical assets 106 to the digital gateway or server 110.

In one case, the physical asset 104 may be embedded with a biometric authentication mechanism within the digital gateway or server 110 to restrict access to the asset-backed I.U's and prevent unauthorized transactions.

In a preferred embodiment, the system 100 introduces a dual-layered architecture consisting of the digital gateway 110 and the ValueBond platform 114, each performing distinct but interconnected roles within the tokenized asset ecosystem. The digital gateway 110 is dedicated to immersive content engagement and interaction, allowing both value-bonded physical asset purchasers 102 and the token holders 112 to upload media, access exclusive experiences, attend real-world events, and actively contribute to the value-bonded physical asset's 106 cultural narrative and perceived value. In one example, the value bond platform 114 may serve one or more gateways 110. Each gateway 110 is uniquely tied to an individual asset 104 and becomes accessible upon initiation of the ValueBonding process. In parallel, the ValueBond platform 114, and its operational core, the server, handle the generation, management, and exchange of tokens, including the creation of intelligent units (I.U.'s) that reflect the evolving tokenized value of the value-bonded physical asset's 106. As part of its suite of functions, the platform or server 114 also continuously monitors engagement metrics, market interest, ownership behavior, and other inputs to calculate a dynamic, real-time market valuation of the value-bonded physical asset 106 when paired with its gateway 110. This valuation forms the basis for token issuance and updates, reflecting the difference between the value-bonded physical asset's 106 standalone value and its enhanced, interaction-driven worth. While the general public may access the ValueBond platform or server 114 to browse available assets or purchase tokens, only verified asset stakeholders are granted access to the corresponding gateway 110. In some embodiments, gateway 110 access is initiated via the ValueBond server 114, enabling a seamless connection between market-based token operations and experiential asset interaction. Assets may be pre-ValueBonded through authorized retailers or submitted to the ValueBond platform 114 for tokenization and gateway 110 onboarding, creating a fully integrated system 100 where value is continuously shaped by both digital engagement and marketplace dynamics.

The digital gateway or server 110 provides access to registering the one or more value-bonded physical assets 106, at least one of ownership records, historical data, provenance, or exclusive digital content related to the value-bonded physical asset 106, enabling digital transactions associated with the value-bonded physical asset 106 through the digital gateway or server 110. The digital gateway or server 110 facilitates at least one of secure transfers, access control, or tokenized representation of the value-bonded physical asset 106. The digital gateway or server 110 is a secure, interactive online portal uniquely tied to each value-bonded physical asset 106. The digital gateway or server 110 functions as the entry point into the value-bonded physical asset's 106 digital life, housing authenticated data, dynamic content, and exclusive brand experiences. The digital gateway or server 110 may include augmented reality views, historical archives, event access, personalization options, and community-driven storytelling. As the first purchasers or owners 102 interact with the gateway 110, they contribute to the value-bonded physical asset's 106 evolving identity and value, creating a living history that reinforces authenticity and deepens the owner's emotional connection.

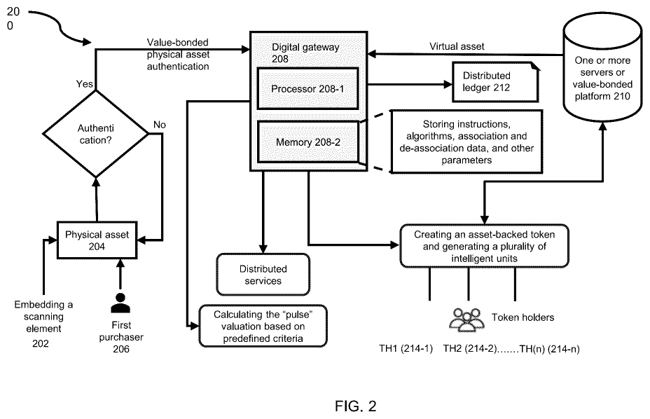

The digital gateway or server 110 may include a processor and a memory (not shown here) to calculate an evolved valuation or a pulse valuation for the asset-backed tokens or digital tokens based on a predefined criteria stored in the memory. The predefined criteria include at least one of the physical asset's 104 initial market value, historical significance, emotional value, or associated digital content exclusivity. The digital gateway or server 110 is connected to a distributed or digital ledger (shown in FIG. 2) to generate a plurality of digital tokens or intelligent units (I.U's) backed by the value bonded physical asset 106. The processor executes instructions or algorithms stored in the memory to carry out the overall operation of the system 100. The memory stores all the relevant parameters or data related to the operation of the system 100 (explained in detail in the figures below). The tokens may be individually owned and exchanged, allowing for broader access to high-value goods that were previously illiquid or exclusive. Tokenization also provides liquidity, democratizes ownership, and enables programmable behaviors such as royalties, dividends, or automated resale rights via smart contracts. Each IU represents a fractional share of the value bonded physical asset's 106 tokenized value and carries embedded metadata, including timestamps, transaction history, and engagement metrics. The IUs are not just financial instruments. The IUs are also used to unlock content, vote in ecosystem governance, or gain tiered access to future product drops or events. The IUs are designed to be dynamic and programmable, evolving alongside the value bonded physical asset's 106 digital lifecycle. The number of the I.U's is derived from dividing the value bonded physical asset's 106 valuation by a predefined currency unit. Further, the asset-backed I.U's are locked or encrypted within the secure distributed or the digital ledger for exchange over the network. As more interactions occur through the digital gateway 110, secondary markets, or community platforms, new layers of value are created and distributed among stakeholders.

The digital gateway or server 110 serves as a dynamic valuation engine for the value-bonded physical asset 106 by continuously tracking market interest and the first purchaser 102 interactions. The system 100 monitors engagement levels, the value-bonded physical asset 106 scan, and unlocking, access frequency, number of interactions, and exclusivity of content associated with the value-bonded physical asset 106, analyzing their impact on token valuation. This ensures that the intelligent units reflect real-time market dynamics and the token holders' 112 behavior. The digital gateway or server 110 adjusts the valuation of I.U's in response to factors such as enhanced access privileges, changes in ownership status, or improvements in the value-bonded physical asset's 106 digital footprint. These recalculated values are securely recorded as immutable transactions, maintaining transparency and trust within the blockchain ecosystem.

This dynamic adjustment mechanism enables the system 100 to capitalize on evolving market trends and the first purchaser 102 or the one or more token holders 112 adoption patterns. By integrating feedback loops between the first purchaser 102 or the token holders 112 interactions and token valuation, the digital gateway or server 110 fosters a robust connection between physical assets 104 and their digital representations. This approach not only enhances the value-bonded physical asset's 106 utility but also accelerates adoption while reducing volatility in token value, aligning with broader principles of tokenomics that emphasize endogenous platform growth and network effects.

The first purchaser or owner 102 retains the physical possession of the value-bonded physical asset 106. The token holders 112 only retain fractional ownership of the intelligent units. The token holders 112 may add new content on the digital gateway 110. The value of the intelligent units rises as the first purchaser 102, or the token holders 112 interact with the system 100. The token holders 112 may suggest how to handle proceeds or legacy access rights. A few exemplary the first purchaser 102 and the token holders 112 scenarios are discussed below:

### First Purchaser Scenarios:

Example 1 (Valuation and Sale Management): David (the first purchaser, 102) holds intelligent units linked to a rare vintage guitar owned by a famous musician. Further, David requests a detailed valuation via the digital gateway 110, which returns a full report on the guitar's current market value and the worth of each IU. Using the platform, David decides to put half of his IUs up for sale, adjusts prices based on demand, and later transfers ownership of some units to the fellow token holders, 112 interested in the guitar's legacy.

Example 2 (Flexible Asset Control): Sophia (the first purchaser 102) acquires IUs connected to a classic sports car. After receiving the valuation report, Sophia opts to sell only the value-bonded physical asset 106 while retaining the intelligent units that grant access to exclusive digital content or vice versa. Further, Sophia can change the price dynamically to attract buyers, managing all transactions seamlessly through the digital gateway 110.

Example 3 (Bundled Sale and Ownership Transfer): Michael (first purchaser 102) owns both value-bonded physical asset 106 and intelligent units tied to a historic artwork. After reviewing the valuation, Michael bundles the value-bonded physical asset 106 and some intelligent units for sale as a package. When a token holder 112 offers a good price, Michael uses the digital gateway 110 to transfer ownership securely, ensuring provenance and transaction transparency.

Example 4 (Price Adjustment and Partial Sale): Emma (first purchaser 102) holds IUs linked to a vintage Rolls-Royce. Further, Emma requests valuation updates periodically and adjusts the sale price of some intelligent units to reflect rising market interest. Emma sells a portion of her IUs while holding onto others, maintaining control over her collectible investment.

### Token Holder Scenarios:

Example 1 (Exclusive Content Access): Liam holds IUs linked to a legendary jazz musician's piano. As a token holder 112, Liam accesses rare audio clips, interviews, and behind-the-scenes footage. Liam also attends virtual events exclusively to IU holders, deepening his connection to the artist's legacy.

Example 2 (Valuation and Trading Decisions): Maria (token holder 112) owns several intelligent units tied to a historic sports memorabilia collection. Maria uses the digital gateway or server 110 to request current valuations of her tokens, helping her decide whether to hold, sell, or trade based on market trends and rarity.

Example 3 (Special Event Participation): Raj holds IUs connected to a famous athlete's signed jersey. Through his token ownership, he receives an invitation to attend exclusive meet-and-greets and private webinars. These events enhance his fan experience beyond mere ownership.

Example 4 (Community Engagement and Rewards): Anna, a token holder of digital collectibles linked to a classic film star's memorabilia, participates in a referral program that rewards her with bonus content. Anna moves up the collector leaderboard showcased on the platform, gaining recognition among peers.

Example 5 (Digital Keepsake and Legacy Connection): Carlos owns intelligent units tied to a historic vintage car. Beyond trading, Carlos values the digital keepsake as a connection to automotive history and enjoys curated content that narrates the car's story, enriching his ownership experience

Further, an insurance policy in the value-bonded physical asset 106 is a blockchain-integrated safeguard tied to the physical asset's 104 lifecycle. Triggered by the smart contracts, this policy automatically initiates actions, such as repair, replacement, or partial refund, in the event of physical damage, theft, or loss. The inclusion of insurance adds an additional layer of trust and mitigates risk for both the first purchaser 102 and the token holders 112.

The value-bonded physical asset 106 incorporates a display of value (DOV), a visual interface that communicates the intelligent units' (I.U's) valuation through non-verbal signals, including color and symbol codes. These codes correspond to key metrics such as the asset's valuation tier, access privileges to the digital gateway or server 110, or the number of available I.U's, with all data securely stored in the memory. The DOV operates as a programmable or dynamically updating display, reflecting real-time changes in the physical asset's 104 value, the first purchaser's 102 interactions, or the digital gateway's 110 activity. The update is triggered by an algorithm or artificial intelligence algorithms or machine-learning models for analyzing market demand, digital engagement metrics, or transaction history. For instance, shifts in interaction frequency or token usage trigger updates to the color or symbol coding, providing immediate visual feedback on market engagement and token dynamics.

Beyond valuation, the DOV serves as a tamper-proof authentication tool by embedding a location-tracking mechanism to verify the physical asset's 104 physical integrity. The DOV displays ownership status and transaction history via a unique identifier, which updates automatically upon verified transfers over the secured network. The display of value may be further configured to display an ownership authentication marker, and the marker is updated each time the asset-backed token is transferred to a new purchaser. The system 100 also enables the token holders 112 to remain the same if the first purchaser 102 sells the value-bonded physical asset 106 to the new purchaser or owner. This ensures the DOV remains permanently linked to the physical asset 104, preventing unauthorized removal and maintaining alignment between the physical asset 104 and its digital tokenized counterpart 106. By combining real-time visual indicators with cryptographic security, the DOV bridges physical and digital ecosystems, enhancing transparency and trust in the physical asset's 104 valuation and ownership lifecycle. The asset-backed token may further comprise an integrated auditing mechanism that verifies and logs all valuation updates, transactions, and ownership changes over the distributed or digital ledger for regulatory compliance and fraud prevention.

This overall process is also known as pulse tokenization, which redefines the physical asset tokenization by transforming static ownership into a dynamic, participatory ecosystem. In a nutshell, the valuebond framework, which is the core of the system 100, embeds physical or digital assets with secure identifiers that anchor real-time feedback loops between the value-bonded physical asset 106 and the digital ecosystem. This “chip-to-token flow” converts the physical asset 104 into the intelligent units, which are programmable tokens that evolve based on community engagement, market sentiment, and cultural relevance. Unlike traditional models, the I.U.s represent living bonds with assets, where value is shaped by active participation, access to exclusive content, and real-world signals like social trends or event attendance, all processed via decentralized infrastructure (e.g., Chainlink Functions and Data Feeds) to ensure responsiveness and transparency. The Chainlink Functions may collect data, including but not limited to real-time off-chain data, social engagement data, streaming activity, new trends, or attendance scans.

The system's 100 utilizes pulse score to quantify the value-bonded physical asset's 106 cultural energy and engagement, visualized through the dynamic display of value indicators that update color/symbol codes in real time. This creates a flywheel where increased interaction, through scans, unlocks, or narrative contributions, elevates the I.U.'s value and utility. By integrating the decentralized data streams and smart contracts, the pulse tokenization turns the value-bonded physical asset 106 into programmable experiences, prioritizing motion and community-driven narratives over passive scarcity. The result is a new asset class where value thrives on attention, access, and shared storytelling, reimagining ownership as a culturally alive, participatory relationship.

In one example, the digital gateway or server 110 may launch a Spotify campaign to promote and sell 50,000 intelligent units priced at $10 each, linked to Marvin Gaye's iconic 1970s Rolls-Royce. Targeting his 21 million monthly Spotify listeners, the campaign offers fans a unique digital collectible experience that connects them to Marvin's legacy through secure, tradeable digital tokens tied to the physical Rolls-Royce Silver Cloud III. Owners of these IUs unlock exclusive content like rare music clips, interviews, and historical archives, deepening their connection to Marvin's story. The campaign uses Spotify's audio and video ads to evoke the luxury and cultural significance of the car, inviting listeners to “own part of Marvin's ride.” The digital gateway or server 110 enables purchasers to trade, price, or transfer their IUs easily. The campaign targets Marvin Gaye fans, classic soul enthusiasts, vintage car collectors, and legacy music lovers across key markets, with incentives like limited-edition digital art for early buyers and referral rewards to boost engagement. The IUs are digital keepsakes without physical ownership rights, ensuring transparency. This campaign blends physical heritage, digital ownership, and exclusive streaming content into a compelling collectible offering.

FIG. 2 illustrates a system 200 for generating asset-backed tokens by integrating physical and digital assets. The system 200 begins with a value-bonded physical asset 204, such as a tangible item of value, which is embedded with or connected to a scanning element 202. A first purchaser 206 initiates the process by scanning the value-bonded physical asset 204 to authenticate the validity. If authentication succeeds, the system 200 grants access to a digital gateway or server 208, which includes a processor 208-1 and memory 208-2. This server 208 acts as a central hub, linking the authenticated value-bonded physical asset 204 to digital or virtual assets provided by one or more servers or value-bonded platform 210. The value-bonded platform or server 210 facilitates a dynamic and secure marketplace for the value-bonded physical asset 204 or intelligent units by enabling the first purchaser 206 or token holders 214 to engage in registration, sale, or purchase activities. The value-bonded platform or server 210 is designed to provide a structured environment where the initial buyer, referred to as the first purchaser, can register the value-bonded physical asset 204 or intelligent unit, thereby establishing a verifiable claim of ownership on the value-bonded platform or server 210. This registration process is crucial as it ensures that the value-bonded physical asset 204 or intelligent unit is officially recognized within the system 200, allowing for transparent and traceable transactions.

Once registered, the value-bonded platform or server 210 empowers the token holders 214, individuals or entities holding tokens that represent fractional or whole ownership, to sell or buy the value-bonded physical assets 204 or units. This capability introduces liquidity and flexibility into the market, enabling the token holders 214 to trade their stakes efficiently. The value-bonded platform or server 210 thus acts as a marketplace that supports the exchange of ownership rights seamlessly, leveraging blockchain or similar technologies to ensure security, transparency, and immutability of transaction records.

By allowing both the first purchaser 206 and subsequent token holders 214 to register, sell, or buy the value-bonded physical assets 204, the value-bonded platform 210 creates an ecosystem that supports asset tokenization and democratizes access to ownership. The system 200 may accommodate various asset types, including physical goods and intelligent units, which may refer to smart, digitally enhanced assets with embedded functionalities. Overall, the value-bonded platform or server 210 enhances asset management and trading by combining traditional ownership concepts with modern tokenization and digital transaction capabilities.

If authentication fails, the first purchaser 206 must rescan the value-bonded physical asset 204 to proceed. Once validated, the server 208 associates the physical asset with the digital assets, enabling the creation of secure, blockchain-based tokens that represent ownership or value in the digital-value add of the physical asset, facilitating transparent and efficient exchange in digital marketplaces.

The processor 208-1 may comprise a single or multi-core processor. The processor 208-1 executes software instructions, algorithms, association or de-association data, or other parameters to implement functional aspects of the present invention. The processor 208-1 may also be implemented as a digital signal processor (DSP), a microcontroller, a designated system on chip (SoC), an integrated circuit implemented with a field programmable gate array (FPGA), an application-specific integrated circuit (A SIC), or a combination thereof. The processor 208-1 can be implemented using a co-processor for complex computational tasks. The processor 208-1 is integrated with the memory 208-2. The processor 208-1 utilizes logic stored in the memory 208-2 to execute and control any number of operations simultaneously. The processor 208-1 may include one or more specialized hardware, software, and/or firmware modules (not shown) specially configured with particular circuitry, instructions, algorithms, or data to perform functions of the disclosed methods. The processor 208-1 may be a general-purpose computer processor that executes commands or instructions but may utilize any of a wide variety of other technologies, including special-purpose hardware, a microcomputer, mini-computer, mainframe computer, programmed micro-processor, micro-controller, peripheral integrated circuit element, a customer specific integrated circuit (CSIC), a logic circuit, a programmable logic device (PLD), a programmable logic array (PLA), RFID processor, smart chip, or any other device or arrangement of devices that are capable of implementing the operations of the processes of embodiments of the present invention. The processor 208-1 associates the value-bonded physical asset 204 and the digital asset. Further, the processor 208-1 creates a token with the help of a distributed ledger 212 and the instructions or algorithms stored in the memory 208-2.

The memory 208-2 may include any of the volatile memory elements (for example, random access memory, such as Dynamic Random Access Memory (DRAM), Static Random Access Memory (SRAM), Synchronous Dynamic Random-Access Memory (SDRAM), etc.), non-volatile memory elements (for example, Read-only memory (ROM), hard drive, etc.), magnetic, semiconductor, tape, optical, removable, non-removable, or other types of storage device or tangible and combinations thereof. Typical forms of non-transitory media include, for example, a flash drive, a flexible disk, a hard disk, a solid state drive, magnetic tape or other magnetic data storage medium, a Compact Disc Read-Only Memory (CD-ROM) or other optical data storage medium, any physical medium with patterns of holes, a non-transitory computer-readable medium, Random-access memory (RAM), a Programmable Read-Only Memory (PROM), and Erasable Programmable Read-Only Memory (EPROM), a Flash-Erasable Programmable Read-Only Memory (EPROM), other flash memory, Non-Volatile Random-Access Memory (NVRAM), a cache, a register, other memory chip or cartridge, or networked versions of the same. The memory 208-2 may have a distributed architecture, where various components are situated remotely from one another but can be accessed by the processor 208-1. The memory 208-2 may include one or more software programs or algorithms (machine, AI, or deep learning algorithms), parameters, market data, association/de-association data, Chainlink data, pulse score data, each of which includes an ordered listing of executable instructions for implementing logical functions.

The system 200 may include one or more different modules, although these are not shown in the current description, that are specifically designed to perform various critical functions such as valuation, sale, purchase, dynamic pricing, and tokenization. Each module serves a distinct purpose within the system's 200 overall architecture, allowing it to handle complex tasks efficiently and effectively. For example, a valuation module could analyze data to determine the current worth of assets or services, providing accurate and timely assessments. Sale and purchase modules would manage the processes of listing items for sale, facilitating transactions, and ensuring secure exchanges between buyers and sellers. A dynamic pricing module would enable the system 200 to adjust prices automatically based on real-time market conditions, demand fluctuations, or other relevant factors, helping to optimize pricing strategies and maximize value. Additionally, a tokenization module could convert assets into digital tokens, allowing for easier management, transfer, and trading of ownership rights within the system 200. By incorporating these diverse modules, the system 200 gains the flexibility and capability to support a wide range of economic and transactional activities, making it adaptable to various use cases and market needs.

The system 200 employs the processor 208-1 to generate intelligent units for token holders (TH1, TH2, . . . . TH(n)), enabling fractional ownership of the value-bonded physical asset 204. Each IU represents a digital stake corresponding to a proportional share of the value-bonded physical asset's 204 appraised or market value, allowing multiple parties to benefit from its financial performance without requiring full ownership or physical custody. This fractional exposure model democratizes access to high-value assets, opening opportunities for investors, collectors, or enthusiasts to participate in a flexible, liquid manner. By leveraging blockchain technology, the system 200 ensures transparency and security in tracking ownership and value distribution, transforming traditional asset management into a decentralized, inclusive framework.

The digital gateway or server 208 further enhances engagement through distributed services such as product documentaries, virtual studio tours, archival assets, and augmented reality (AR) or virtual reality (VR) experiences. These features provide token holders (214-1, 214-2, . . . 214-n) with immersive, interactive access to the asset's ecosystem, bridging physical and digital realms. The integration of fractional ownership with advanced digital tools not only increases liquidity but also fosters broader participation in markets traditionally limited to high-net-worth individuals. This innovative approach redefines asset interaction, offering stakeholders a seamless blend of financial utility and experiential value while maintaining transparency through blockchain-backed tokenization. The detailed working of the system 200 is explained in FIG. 1.

The token holders (214-1, 214-2, . . . 214-n) may create their own content and add it to the digital gateway or server 208. Further, based on the interaction, engagement activity, gateway access, event invitation, and many other factors discussed above, the value of the intelligent units or the value-bonded physical asset 204 varies, and the same is reflected on the digital gateway or the server 208. In one example, the token holders (214-1, 214-2, . . . 214-n) may create a video branding the movie or clothes associated with the value-bonded physical asset 204 and post it on a Y ouTube and Instagram channel. This will attract the fans of the movie or the actor. Based on the number of views on the video, the number of re-shares, and tags, the processing module 208-1 calculates the value of the intelligent unit and divides the value between the token holders (214-1, 214-2, . . . 214-n) and the value-bonded physical asset 204. The processing module 208-1 utilizes instructions, algorithms, pulse score, chain link functions, or other types of data stored in the memory 208-2 (as discussed above) to carry out the valuation. The value is either equally divided or unequally divided. In one example, the token holders (214-1, 214-2, . . . 214-n) are either active token holders or passive token holders. The active token holder posts content, attends events, or accesses exclusive content, which results in token valuation. Whereas the passive token holder only buys an intelligent unit and still benefits from the active token holder.

The token holders (214-1, 214-2, . . . 214-n) have the unique ability to create and contribute original content, such as videos, articles, digital art, or event invitations, to a digital gateway or server 208. This content is not only a means of engagement but also a driver of value within the ecosystem. The value of each intelligent unit or the associated value-bonded physical asset 204 dynamically fluctuates based on several quantifiable factors, including user interactions (likes, shares, comments), engagement activity (event attendance, content consumption), gateway access (exclusive content unlocks), and participation in community events.

The processing module 208-1 leverages algorithms, pulse scores, chain link functions, and other data stored in memory 208-2 to calculate and update the value of each intelligent unit in real time. The resulting value is then distributed among participating token holders (214-1, 214-2, . . . 214-n) and the value-bonded physical asset 204, either equally or based on individual contributions and engagement levels. Active token holders, those who create content, attend events, or interact with the platform, can directly influence token valuation and benefit from increased rewards. Passive token holders, on the other hand, may still gain value through the efforts of active participants, reflecting a collaborative and incentivized ecosystem.

This model mirrors the broader trend in digital content economies, where tokens represent not only ownership and royalty flows but also governance power, community participation, and transparent, automated compensation for creative contributions. Different exemplary scenarios of content creation and valuation are listed below:

### Exemplary Scenarios

Scenario 1 (Collaborative Video Campaign for a Movie Release): Several token holders (214-1, 214-2, . . . 214-n) collaborate to produce a series of promotional videos for a new movie tied to a value-bonded physical asset 204 (e.g., limited-edition merchandise). The videos are uploaded to platforms like YouTube and Instagram, with each token holder (214-1, 214-2, . . . 214-n) leveraging their social networks to maximize reach. The processing module 208-1 tracks metrics such as views, shares, and engagement, and uses this data to update the value of the intelligent units. As the campaign gains traction, the increased value is automatically distributed among the active token holders who contributed to the content, as well as the physical asset itself, reflecting the collective impact of their promotional efforts.

Scenario 2 (Exclusive Content Series and Fan Engagement): A token holder (214-1, 214-2, . . . 214-n) creates an exclusive behind-the-scenes content series related to a popular fashion brand associated with a value-bonded asset 204. Access to this content requires holding a minimum number of tokens, incentivizing fans to purchase and hold tokens for exclusive experiences. The processing module 208-1 evaluates engagement metrics (e.g., number of unlocks, time spent viewing, fan comments) and adjusts the token value accordingly. Active token holders who produce or curate the content receive a larger share of the increased value, while passive holders benefit from the overall rise in token valuation due to heightened platform activity.

Scenario 3 (Community Event and Governance Participation): Token holders (214-1, 214-2, . . . 214-n) organize a virtual event (e.g., a live Q&A with a celebrity or designer linked to the value-bonded asset 204). Participation in the event is tracked, and attendees receive additional rewards or voting power for future platform decisions. The event's success is measured by attendance, social media buzz, and post-event content creation, which boosts the value of the intelligent units. The processing module 208-1 allocates value increases based on both event participation and subsequent content creation, fostering a sense of community ownership and incentivizing ongoing engagement.

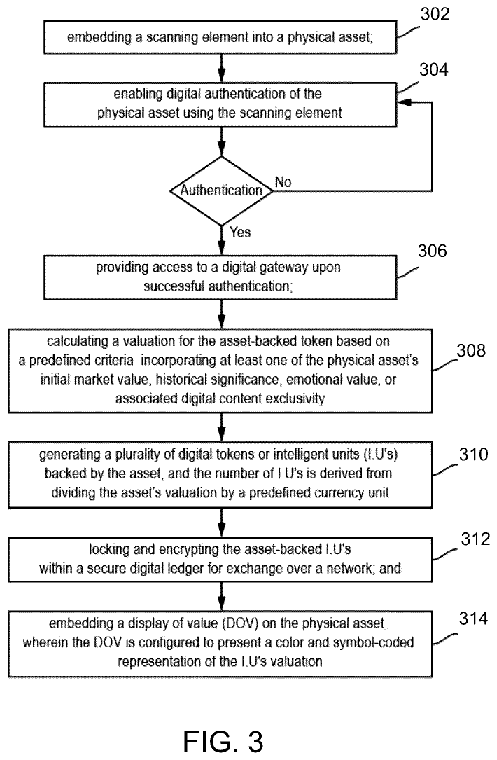

FIG. 3 illustrates a process flow diagram 300 for generating an asset-backed token for exchange in accordance with an embodiment of the present invention. The method 300 comprises the steps of:

Step a): Embedding a Scanning Element (302): A scanning element is embedded into a physical asset to facilitate its identification and tracking. This ensures the physical asset is digitally linked to its tokenized representation.

Step b): Digital Authentication (304): The scanning element enables digital authentication of the physical asset. The step ensures the asset's legitimacy, provenance, and compliance with predefined criteria, such as ownership records, condition checks, or third-party appraisals.

Step c): Access to Digital Gateway (306): Upon successful authentication, access (306) to a digital gateway is granted. This gateway serves as the interface for content access and engagement, while a separate server or ValueBond platform facilitates the tokenization features. Alternatively, the gateway may also be integrated, launching the subsequent tokenization workflows, including token generation and/or exchange. If authentication fails, the method process (300) is repeated until successful. Further, the server or gateway acts as a secure, blockchain-integrated platform, equipped with computational resources (e.g., processor 208-1 and memory 208-2, as mentioned in the above figures) to manage tokenization workflows, smart contracts, and interactions with external systems like third-party servers or decentralized ledgers.

Step d): Asset Valuation (308): The valuation of an asset-backed token is calculated based on predefined criteria. These criteria may include the initial market value of the physical asset, historical significance, emotional value, or exclusivity of associated digital content.

Step e): Token Generation (310): A set of digital tokens or intelligent units (I.U.'s) is generated, backed by the asset. The number of tokens is determined by dividing the asset's valuation by a predefined currency unit. The tokens generated or intelligent units represent fractional ownership stakes in the authenticated physical asset. These IUs are programmatically linked to the asset's appraised value, enabling dynamic pricing and real-time updates based on market conditions or performance metrics. Token holders (TH1, TH2, . . . . TH(n)) receive the IUs, which grant them rights to shared financial benefits (e.g., revenue splits, appreciation gains) without requiring direct physical custody. The gateway further supports additional functionalities, such as automated dividend distributions, secondary market trading, and integration with AR/VR interfaces for immersive asset interactions. By combining secure authentication, blockchain-based tokenization, and fractional ownership mechanisms, this method (300) democratizes access to high-value assets, enhances liquidity, and ensures transparent, auditable ownership records across decentralized networks.

Step f): Locking and Encryption in Digital Ledger (312): The generated tokens are locked and encrypted within a secure digital ledger, ensuring their integrity and enabling exchange over a network.

Step g): Embedding Display of Value (DOV) (314): A Display of Value (DOV) is embedded on the physical asset. This display uses color and symbol coding to represent the valuation of the I.U.'s visually.

This method (300) integrates physical assets with blockchain technology, providing security, transparency, and fractional ownership opportunities for investors. The method (300) combines elements like smart contracts, valuation algorithms, and secure ledgers to create a robust framework for tokenization.

The method (300) further allows the first purchaser to resell the value-bonded physical asset. Notably, this resale does not affect the rights or claims of existing token holders. The tokens or intelligent units (IUs) generated during the initial tokenization event remain valid and active, independently linked to the digital gateway and the underlying metadata of the asset. Token holders may continue to interact with the digital ecosystem, engaging with content, trading their tokens, or deriving value, regardless of who possesses the physical asset.

When the first purchaser initiates a liquidation event through tokenization, they effectively unlock fractionalized digital ownership via smart contract execution, yet they still retain physical possession of the item. This unique dynamic allows them to engage with the asset in real life (IRL), exhibiting, storing, or utilizing it, while the token holders participate through a digitally mediated ownership experience. Upon resale of the physical asset, the second purchaser acquires the item along with its digital bindings and obligations to the tokenized structure. Thus, while physical custody changes, the distributed token ownership remains intact, continuing to reflect value and utility tied to the asset via the digital gateway across any number of owners of the physical asset.

This model introduces nuanced governance challenges by decoupling possession from ownership, creating a layered asset interaction structure. The rights and responsibilities of the possessor versus those of the token holders must be clearly delineated, particularly in cases involving resale, disputes, or asset degradation. As such, smart contracts and associated governance protocols become central to maintaining a balanced and transparent system where both physical and digital stakeholders operate with clearly defined, enforceable roles.

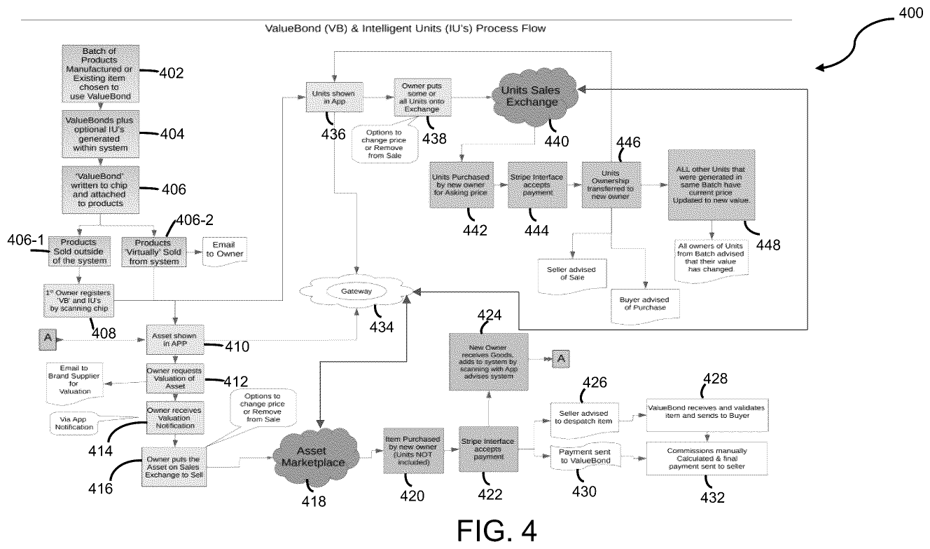

FIG. 4 illustrates a detailed process flow diagram 400 for the lifecycle of a Value Bond (VB) and its associated Intelligent Units (IUs), encompassing registration, valuation, fractionalization, exchange, and resale dynamics of a value-bonded physical asset in accordance with an embodiment of the present invention. The process 400 comprises the steps of:

The process 400 begins with a batch of manufactured or existing products selected (402) for integration with the Value Bond ecosystem. Each item is embedded (406) with a VB chip, digitally encoded with metadata, and optionally paired with IUs (404). Upon acquisition, the first owner scans the chip to register (408) the asset within the system. These value-bonded products are either sold outside (406-1) the system or virtually sold (406-2) from the system by emailing the owner or purchaser. This registration (408) triggers the generation of IUs within the platform, allowing fractional stakes to be managed and visualized (410) in the application interface.

### Continuation an Part Application

Once registered (408), owners can engage the system through several pathways. They may request (412) a valuation of the asset via the app, initiating a communication workflow between the brand supplier and owner. After receiving a valuation notification (414), the owner can opt to list either the physical asset or any number of IUs for sale (416). These can be listed on a dedicated Asset Marketplace (for physical items) (418) or the Units Sales Exchange (for fractional units). In both cases, listing and price controls are managed via a secure digital gateway or VB platform.

When IUs are sold (420) through the Units Sales Exchange, the Stripe payment interface processes (422) the transaction, and ownership of the IUs is transferred (424) to the new buyer. Importantly, the sale of IUs in one asset batch dynamically updates the valuation of all remaining IUs tied to that batch, with notifications issued to existing holders. This ensures transparent, real-time market pricing across distributed fractional owners.

Simultaneously, if the physical asset itself is sold through the Asset Marketplace, the system notifies the seller to dispatch (426) the item. Stripe processes (422) the payment, and the item is sent to Value Bond (428) for validation before final delivery to the new owner. Commissions (430, 432) are manually calculated, and the remaining balance is forwarded to the original seller. Notably, the purchase of the physical item does not include the IUs unless explicitly bundled, maintaining the independence of digital ownership from physical possession. However, the I.U.'s will always remain tethered to the physical asset, regardless of the chain of custody of the physical asset.

Once received, the new owner can scan (410) the asset with the app to onboard it into their account, reactivating (434) the gateway and allowing continued participation in the Value Bond ecosystem.

This process flow (400) reveals an advanced governance framework where possession and tokenized ownership are functionally decoupled. Token holders retain rights, access, and values tied to the digital representation of the asset regardless of its physical custodian. The system ensures that all participants, whether they hold tokens, own the asset, or both, operate (436-448) within a transparent, blockchain-backed infrastructure that supports dynamic pricing, equitable transactions, and decentralized ownership continuity.

In some embodiments, value bonding an asset enables the user to perform one or more of the following: digital authentication, access and interaction with a digital gateway, and/or tokenization. In certain configurations, value bonding functions solely to authenticate the asset. In others, it serves only to enable access and interaction with the digital gateway. In yet another set of embodiments, value bonding exclusively provides the option to tokenize the asset into Pulse Tokens or Intelligent Units (IU s).

Scanning the embedded element by the first purchaser activates one, two, or all three of these features, depending on system configuration. In some cases, authentication is a prerequisite to gateway access and/or tokenization. In alternative embodiments, authentication and gateway access may be granted upfront, whether as earned credits, privileges, or system defaults, prior to initiating tokenization.

In yet other implementations, all three post-value bonding functionalities (authentication, gateway access, and tokenization) are coordinated and managed by a digital gateway manager. Upon scanning, the digital gateway manager is initialized, providing the first purchaser with the ability to authenticate, interact with the gateway, and/or tokenize the asset. In such embodiments, the manager oversees the full spectrum of post-activation features. Alternatively, the digital gateway manager may be limited in scope to control content flow within the gateway, operating independently of authentication and tokenization mechanisms.

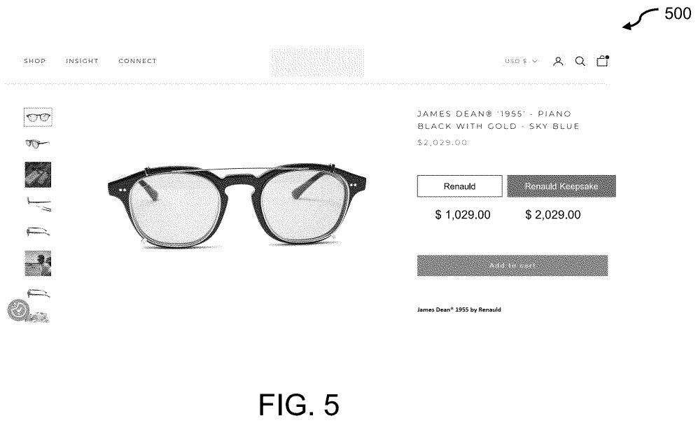

FIG. 5 illustrates a screenshot of a landing page 500 that demonstrates the process of selecting a value-bonded physical asset or product for value-bonding on a dedicated platform or server, in line with an exemplary embodiment of the present invention. The landing page 500 is designed to provide first purchaser, such as John Doe, with clear options regarding the status of the asset in this case, Renuald sunglasses. John Doe is presented with the choice to select either value-bonded Renuald sunglasses, which are already bonded and carry an associated value, or Renuald sunglasses that have yet to be value-bonded and would require the bonding process at a later stage. The interface dynamically adjusts the price based on John Doe's selection, reflecting the added value and security provided by the value-bonding process. Once the preferred option is chosen, John Doe may proceed to purchase the sunglasses by completing the payment process directly through the platform. This streamlined workflow not only enhances user experience by offering transparency and flexibility but also integrates the value-bonding mechanism into the purchasing journey, ensuring that users can make informed decisions about the assets they acquire.

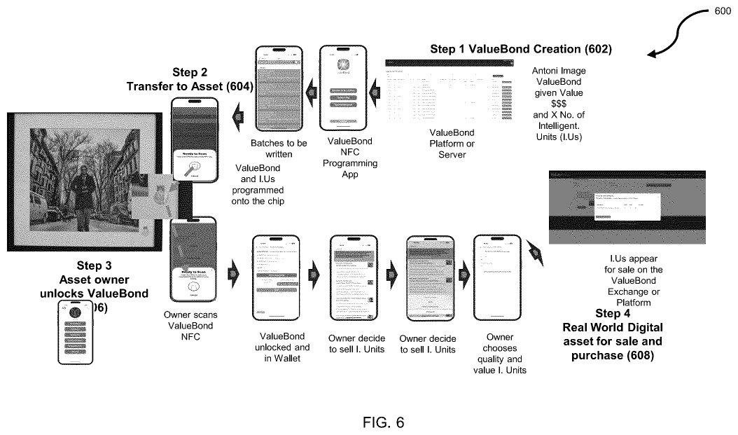

FIG. 6 illustrates a screenshot of a landing page 600 that visually represents the step-by-step graphical flow of value bond creation, the transfer of a value-bonded physical asset, and the process by which the first purchaser, John Doe, unlocks the value-bond and lists the real-world digital asset for sale or purchase, in accordance with an exemplary embodiment of the present invention. The graphical flow 600 begins with ValueBond Creation (602), where John Doe registers his value-bonded Renuald sunglasses and associated intelligent units, along with their corresponding values, on the value-bond platform or server. This registration is reflected on a digital gateway or server, which includes integration with an NFC programming application. The next step, Transfer to Asset (604), involves value-bonding the raw Renuald sunglasses by embedding a chip with a keepsake, thereby transforming them into a value-bonded physical asset. Following this, the Asset Owner Unlocks ValueBond (606) step allows John Doe to scan the ValueBond NFC using a mobile application, unlocking the ValueBond and gaining access to the digital gateway or server. Finally, in the Real World Digital Asset For Sale and Purchase (608) step, John Doe selects one or more intelligent units for sale or purchase on the digital gateway or server, with these actions being reflected in real time on the ValueBond Platform or Exchange. This comprehensive process ensures a secure, transparent, and efficient transition from physical asset registration to digital marketplace participation, leveraging both physical and digital security mechanisms.

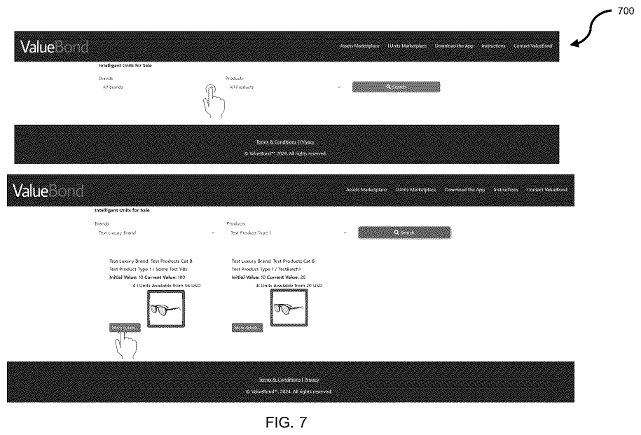

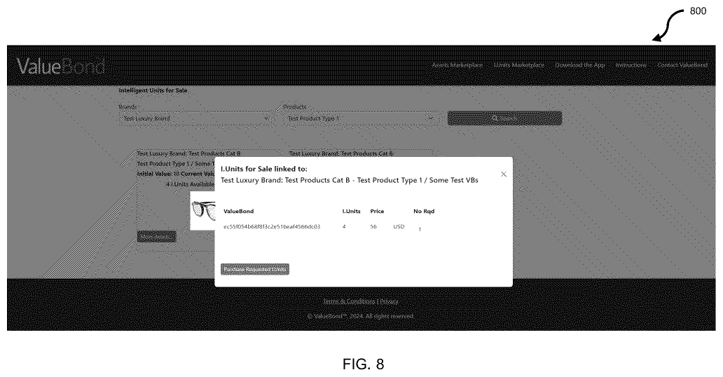

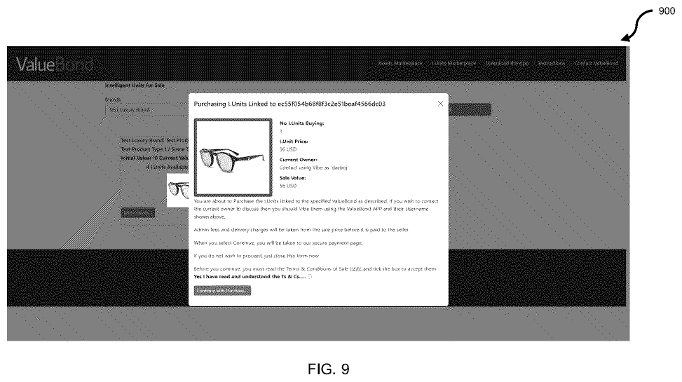

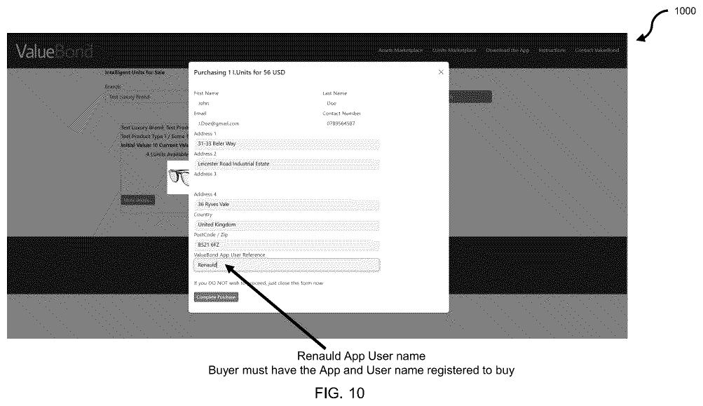

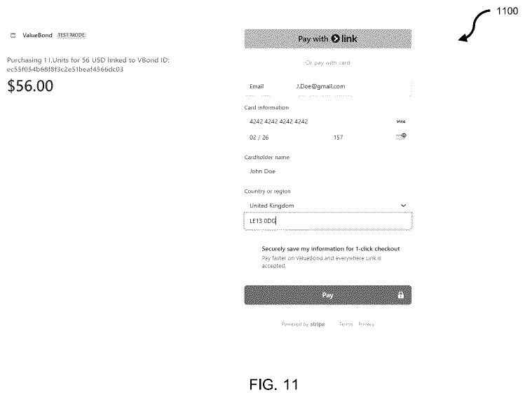

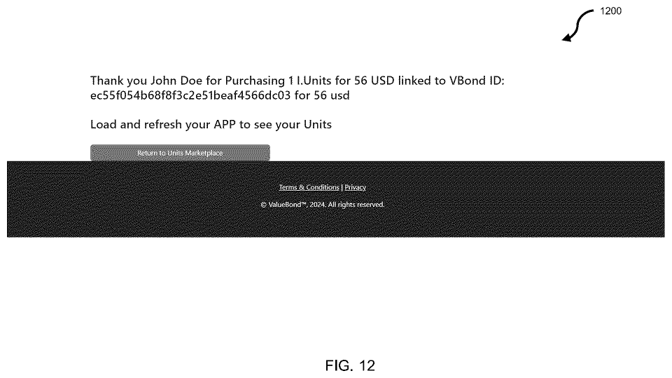

FIGS. 7-12 illustrate a series of landing pages (700, 800, 900, 1000, 1100, 1200) on a value bond platform that guides the user through the process of selecting and purchasing intelligent units, in accordance with an exemplary embodiment of the present invention. The landing pages (700, 800, 900, 1000, 1100, 1200) provide John Doe with the option to choose a brand and view the corresponding available products for that brand. The interface then prompts John Doe to complete a customer form, which includes fields for name, email ID, address, and a reference to the ValueBond App. Following form completion, John Doe proceeds to perform the payment process. Upon successful payment, a confirmation notification is displayed, indicating that the intelligent units are now available on the digital gateway or server and accessible through the application. This streamlined sequence ensures a user-friendly experience for purchasing intelligent units while integrating the value-bond platform's secure and real-time asset management capabilities.

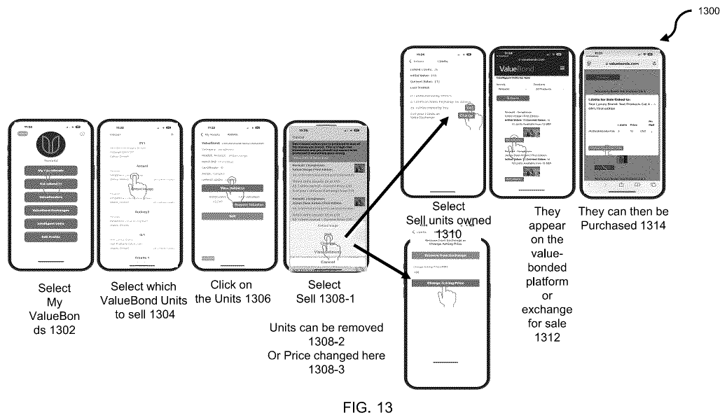

FIG. 13 illustrates a screenshot of landing page 1300 on the ValueBond A pp, depicting the process of selling intelligent units in accordance with an exemplary embodiment of the present invention. On this landing page, John Doe performs several key steps: selecting (1302) a ValueBond followed by choosing (1304) the specific ValueBond intelligent units he wishes to sell. John then clicks (1306) on the selected intelligent units to initiate the selling process. John Doe is provided with options to either sell (1308-1) the intelligent units remove (1308-2) them from sale, or change (1308-1) their price. After selecting (1310) the owned intelligent units to sell, the units appear (1312) on the value-bonded platform as available for sale. Finally, the process concludes with the purchasing (1314) of the units, enabling a seamless transaction within the ValueBond ecosystem. This workflow integrates asset management and marketplace functionalities, allowing users to efficiently control and monetize their value-bonded digital assets.

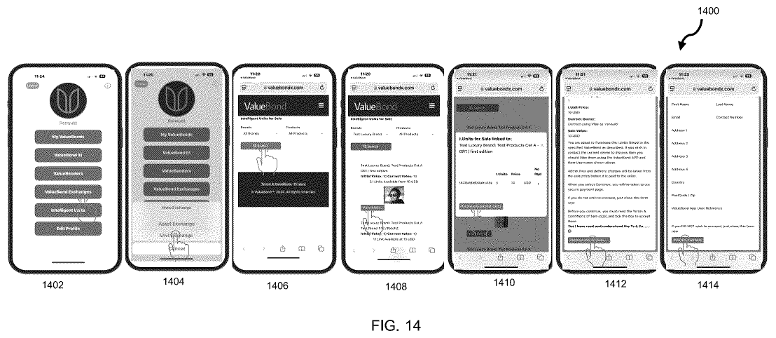

FIG. 14 illustrates a screenshot of landing page 1400 depicting the process of buying intelligent units on the ValueBond App in accordance with an exemplary embodiment of the present invention. On this landing page, John Doe performs the steps of: clicking (1402) on the value bond exchange, selecting (1404) the unit exchange, choosing (1406) the brand and the corresponding product for the units, checking (1408) the details of the selected product, purchasing (1410, 1412) the selected product, and finally completing (1414) the purchase by filling in the customer information. This sequence ensures a streamlined and user-friendly experience for acquiring intelligent units through the ValueBond platform.

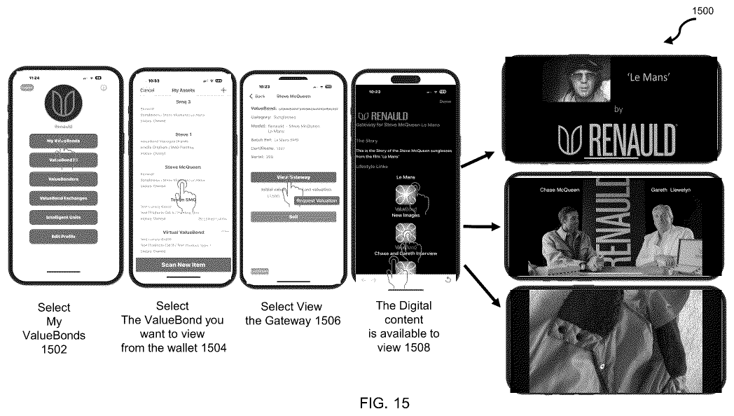

FIG. 15 illustrates a screenshot of landing page 1500, which depicts a gateway on the Value Bond App in accordance with an exemplary embodiment of the present invention. On this landing page, John Doe begins by selecting (1502) valuebonds from his available options. John then selects (1504) the specific value bond he wishes to view from the list of valuebonds. Next, John Doe clicks (1506) on the “view gateway” option, which grants him access to the gateway associated with the chosen value bond. Finally, John is able to view (1508) the digital content available on the gateway, providing a seamless and interactive experience for managing and accessing digital assets linked to his value bonds within the application.

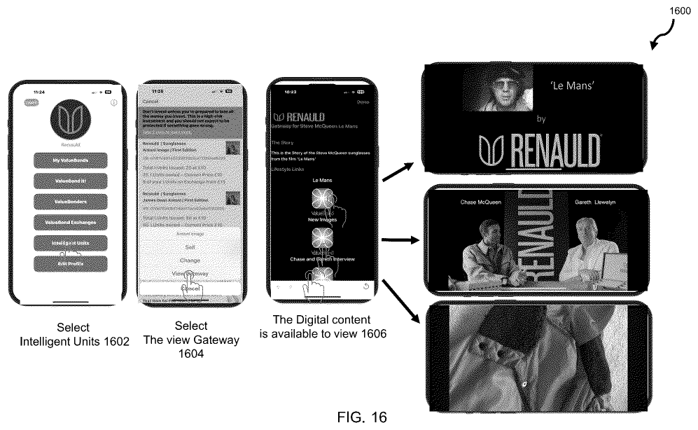

FIG. 16 illustrates a screenshot of landing page 1600 depicting a gateway on the Value Bond App specifically for intelligent units, in accordance with an exemplary embodiment of the present invention. On this landing page, John Doe performs the steps of selecting (1602) intelligent units, clicking (1604) on the view gateway option, and subsequently viewing (1606) the digital content available on the gateway. This process enables John Doe to seamlessly access and interact with digital assets linked to the intelligent units through the Value Bond App, providing a secure and integrated platform for managing value-bonded physical assets and their associated digital representations.

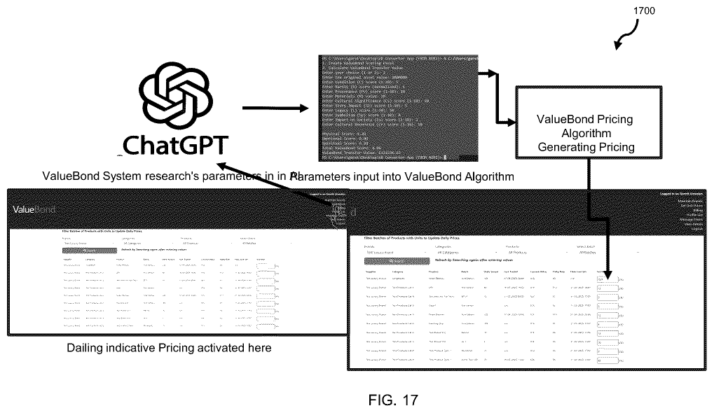

FIG. 17 illustrates a screenshot of landing page 1700 depicting a daily indicative price update for ValueBond on the ValueBond platform in accordance with an exemplary embodiment of the present invention. The platform utilizes one or more parameters or algorithms, as described in the preceding figures, to dynamically update the price of the ValueBond. This continuous price adjustment reflects real-time market conditions and ensures that the ValueBond's valuation remains accurate and transparent for users. Such algorithm-driven updates enable the platform to provide timely and reliable pricing information, enhancing trust and facilitating informed decision-making for buyers and sellers within the ValueBond ecosystem.

While the current invention has been described in detail with reference to the preferred embodiment, it is understood that various modifications and variations can be made without departing from the spirit and scope of the invention. The embodiments described herein are to be considered in all respects as illustrative and not restrictive. The scope of the invention is, therefore, indicated by the appended claims rather than the foregoing description. All changes that fall within the meaning and range of equivalency of the claims are intended to be embraced within their scope.

### Glossary

ValueBonding: ValueBonding is the foundational process by which a physical asset is transformed into a digitally enhanced asset. This is achieved by embedding a secure, tamper-proof chip (such as NFC or RFID) into the item, which links it to a blockchain-based digital identity. This embedded chip not only authenticates the item's origin and provenance but also connects it to an evolving digital experience. Through this process, the physical asset becomes a hybrid object, one that exists simultaneously in the physical and digital realms. It is now capable of generating new forms of value, participating in tokenized markets, and unlocking immersive engagement opportunities that extend well beyond traditional ownership.

Asset-Backed Token: A digital token representing ownership or fractional ownership of a physical asset (e.g., collectible, luxury item). Its value is directly tied to the underlying asset.

Digital Value-Add: Enhancements or features that increase the value of a physical asset through digital means, such as enhanced authentication, interactive digital experiences, or community engagement.

Pulse Tokenization: The system and method described in the document for generating asset-backed tokens that incorporate a digital value-add, creating a dynamic and interactive connection between the physical asset and its digital representation. It aims to capture and reflect the asset's “cultural pulse” in its digital value.

Intelligent Units (I.U.'s): Digital tokens generated to represent fractional ownership or value associated with a physical asset in the Pulse Tokenization system. The number of I.U.s is determined by dividing the asset's valuation by a predefined currency unit.

Scanning Element: A component embedded in the physical asset that allows for digital authentication and access to a digital gateway.

Digital Gateway: A platform or interface that provides access to information, experiences, and interactions related to the physical asset and its tokenized representation. This may include details about the asset's history, community discussions, or exclusive content.

Valuation: The process of determining the value of the asset-backed token, taking into account factors such as the physical asset's initial market value, historical significance, emotional value, and associated digital content.

Secure Digital Ledger: A blockchain or similar technology used to securely record and manage transactions related to the asset-backed tokens. This ledger ensures that all transactions are immutable, transparent, and auditable.

Smart Contract: Smart Contract is a self-executing code hosted on the blockchain that enforces predefined terms without the need for intermediaries. Within the ValueBond framework, smart contracts govern token issuance, validate transfers of ownership, execute royalties, and trigger protections such as insurance payouts. These contracts introduce transparency, efficiency, and automation into what would otherwise be manual or trust-dependent processes.

Insurance Policy: The Insurance Policy in a ValueBonded system is a blockchain-integrated safeguard tied to the physical asset's lifecycle. Triggered by smart contracts, this policy automatically initiates actions, such as repair, replacement, or partial refund, in the event of physical damage, theft, or loss. The inclusion of insurance adds an additional layer of trust and mitigates risk for both the first purchaser and the token holders.

First Purchaser: The first purchaser is the individual or institution that retains physical custody of the physical asset. While they may not have full economic rights (especially after tokenization), they are responsible for maintaining the asset's condition and integrity. In some cases, possession rights may also be tokenized or leased, enabling innovative custodial models such as shared exhibitions, decentralized lending, or rotational display networks.

Demand Tracking: Monitoring market interest in the physical asset to dynamically adjust the valuation of the I.U.'s, ensuring that the token value remains aligned with current market conditions.

Interaction Monitoring: Tracking user engagement with the digital gateway to determine the impact of digital interactions on the token value. This includes metrics such as access frequency, number of interactions, and content exclusivity.

Display of Value (DOV): A visual indicator embedded on the physical asset that presents a color- and symbol-coded representation of the I.U.'s valuation. It provides a real-time and intuitive representation of the asset's value.

Keepsake Display: A display embedded into a physical asset to showcase a commemorative or historically significant item, enhancing the asset's value and appeal.

Video Recording (Authentication): A process where the scanning element facilitates video recording during the authentication process to document the exact state of the asset and the authentication action itself, creating an immutable visual record.

1. A method for generating an asset-backed token for exchange, said method comprising:
embedding a scanning element into the physical asset, wherein the scanning element is configured to enable digital authentication of the asset and provide access to a digital gateway;
calculating a valuation for the asset-backed token based on a predefined criteria incorporating at least one of the physical asset's initial market value, historical significance, emotional value, or associated digital content exclusivity;
generating a plurality of digital tokens or intelligent units (I.U's) backed by the asset, wherein the number of I.U's is derived from dividing the asset's valuation by a predefined currency unit; and
locking and encrypting the asset-backed I.U's within a secure digital ledger for exchange over a network.

2. The method of claim 1, further comprising tracking the demand for the physical asset and adjusting the valuation of the I.U's based on changes in market interest.

3. The method of claim 1, further comprising monitoring interactions with the digital gateway, including user engagement levels, access frequency, number of interactions, and content exclusivity to determine their effect on the token value.

4. The method of claim 1, further comprising updating the value of the I.U's dynamically in response to at least one of an increase in access privileges, an enhancement of the digital footprint associated with the asset, or a change in ownership status.

5. The method of claim 1, further comprising recalculating the I.U's value based on the modified asset valuation and recording the adjusted value in an immutable transaction.

6. The method of claim 1, further comprising embedding a display of value (DOV) on the physical asset, wherein the DOV is configured to present a color and symbol-coded representation of the I.U's valuation, and wherein the color and symbol code corresponds to at least one of a valuation tier of the asset, the digital gateway access level, or the number of I.U's available.

7. The method of claim 6, wherein the DOV is at least one of a fixed, programmable, or dynamically updating display that changes based on real-time valuation of the asset, the digital gateway, or I.U's.

8. The method of claim 6, wherein the DOV is configured to visually indicate the rate of interaction or usage of the I.U's, wherein a change in the interaction frequency updates at least one of the color or symbol coding on the DOV.

9. The method of claim 6, wherein the DOV is further configured to indicate an ownership status or transaction history of the asset by displaying a unique identifier, wherein the identifier is updated upon a verified transfer of ownership over a secured network.

10. The method of claim 6, wherein the DOV is embedded with a location-tracking mechanism to authenticate the continued presence of the DOV on the asset, preventing unauthorized removal or tampering, and ensuring valuation integrity.

11. A method for generating an asset-backed token for exchange, said method comprising:
embedding a keepsake display into a physical asset, wherein the keepsake display is configured to showcase a commemorative or historically significant item;
embedding a scanning element into the physical asset, wherein the scanning element is configured to enable digital authentication of the keepsake and provide access to a digital gateway;
calculating a valuation for the asset-backed token based on a predefined criteria incorporating at least one of the physical asset's initial market value, historical significance, emotional value, or associated digital content exclusivity;
generating a plurality of intelligent units (I.U's) backed by the asset, wherein the number of I.U's is derived from dividing the asset's valuation by a predefined currency unit;
locking and encrypting the asset-backed I.U's within a secure digital ledger or blockchain system; and
embedding a display of value (DOV) on the physical asset, wherein the DOV is configured to present a color and symbol-coded representation of the I.U's valuation, and wherein the color and symbol code corresponds to at least one of a valuation tier of the asset, the digital gateway access level, or the number of I.U's available.

12. The method of claim 11, wherein the digital ledger for recording and managing the asset-backed I.U's is implemented on a decentralized blockchain network to ensure security, transparency, and immutability of transactions.

13. The method of claim 11, further comprising applying a cryptographic hash function to secure the valuation data and transaction records of the I.U's, preventing unauthorized modifications.

14. The method of claim 11, wherein the scanning element is configured to communicate with a smart contract encoded on the blockchain, wherein the smart contract automatically enforces transaction rules for I.U transfers, asset ownership, and valuation updates.

15. The method of claim 11, wherein the I.U's are configured to be non-fungible tokens (NFTs) or fractionalized digital assets, enabling transferability while maintaining a secure linkage to the underlying physical asset.

16. The method of claim 11, further comprising embedding a biometric authentication mechanism within the digital gateway to restrict access to the asset-backed I.U's and prevent unauthorized transactions.

17. The method of claim 11, wherein the display of value (DOV) is configured to update dynamically based on real-time valuation changes, and wherein the update is triggered by an algorithm analyzing market demand, digital engagement metrics, or transaction history.

18. The method of claim 11, wherein the display of value (DOV) is further configured to display an ownership authentication marker, wherein the marker is updated each time the asset-backed token is transferred to a new owner.

19. The method of claim 11, wherein the asset-backed token system further comprises an integrated auditing mechanism that verifies and logs all valuation updates, transactions, and ownership changes over a distributed ledger for regulatory compliance and fraud prevention.

20. A method for enabling digital access and authentication of a physical asset, said method comprising:
embedding a scanning element within or on a physical asset, wherein the scanning element is configured to store and transmit authentication data associated with the asset;
linking the scanning element to a digital gateway, wherein the digital gateway provides access to at least one of ownership records, historical data, provenance, or exclusive digital content related to the asset; and
enabling digital transactions associated with the asset through the digital gateway, wherein the gateway facilitates at least one of secure transfers, access control, or tokenized representation of the asset.
